(19) United States
(12) Patent Application Publication
(10) Pub. No.: US 2024/0394230 A1
(43) Pub. Date: Nov. 28, 2024

(54) Mainframe Change Data Capture and Streaming Data Tokenization

(71) Applicant: MCKINSEY & COMPANY, INC., NEW YORK, NY (US)

(72) Inventors: Kaustuva Mukherjee, Macungie, PA (US); Dario Cabianca, Georgetown, KY (US); Narayan Venkatraghavan Iyer, Sammamish, WA (US); Aron H. Patel, Plymouth Meeting, PA (US)

(21) Appl. No.: 18/200,187

(22) Filed: May 22, 2023

(51) Int. Cl. G06F 16/21; G06F 16/27

(52) U.S. Cl. CPC G06F 16/214; G06F 16/275

(57) ABSTRACT

To capture changes in data during data migration and update data stored at a local computing system, a cloud server receives local computing data from one or more databases associated with a local computing system while an active application is running on the local computing system, the local computing data including at least (i) one or more application functionalities and (ii) input data used by the active application. The cloud server generates change data using the input data, the change data representative of one or more modifications to the input data by the one or more application functionalities. The cloud server then replicates the change data to generate replicated data for the active application.

### FIELD OF THE DISCLOSURE

The present disclosure relates to data capture and, more particularly, to streaming and tokenizing data from a local computing system to a cloud computing platform while maintaining the data at the local computing system to support an incremental migration of application workloads from the local computing system to the cloud.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

As technology progresses and becomes more ubiquitous, more information is being stored on the cloud to allow for greater access to a greater variety of devices and/or locations. Similarly, reducing the costs of maintaining local computing systems and/or improving agility, flexibility, and scalability of a system may lead companies or individuals to migrate application workloads from an individual local computing structure to the cloud.

However, this migration of workloads to the cloud from a local computing system is a complex process. Typically, these applications are monolithic and have multiple dependencies between such workloads, making it difficult and risky to migrate all the workloads to the cloud together at once.

Furthermore, transferring data to and from a local computing system and cloud is complicated and time-consuming. Because data on the local computing system is often still used by the applications, any delay in data availability during the workload migrations often leads to either shutting down operations until the migration is complete or leads to periodic transfers to ensure all new information is similarly transferred. These options, however, result in either long periods of inoperability or greatly extend the amount of overall time and resources required to perform the migration.

### SUMMARY

To perform a data migration from a local computing system or server to a cloud server, a cloud server may receive transferred data, perform computation tasks on the data, replicate the data, and update the local computing system or server instantaneously while the migration is ongoing. During the migration procedure, when an application and/or functionality is moved off of the local computing system, remaining functions continue to use the data generated by workloads that have been already migrated to the cloud. As such, conventional systems disable such functionalities or do not transfer functionalities until all data has been transferred, if at all. However, by reading and writing any updated data back to the local computing system, the remaining functionalities continue to access updated data from the transferred functionalities. Moreover, such techniques accelerate local computing system migration in general by allowing for constant data migration and by making data available instantly in the cloud. As such, the techniques discussed herein provide a frictionless and seamless migration of data while maintaining the benefits of moving processing to a cloud server.

Moreover, to improve the security and privacy of data during data migration, a cloud server and/or local computing system performing the techniques described herein may encrypt, decrypt, tokenize, detokenize and/or de-identify, the data as the system processes the data. For example, a local computing system or another component of a system associated with the local computing system may tokenize the data prior to or as part of transmitting the data to the cloud server. The cloud server, while updating the data at the local computing system, may then detokenize the data prior to or as part of transmitting the data. Similarly, the cloud server may store the data in the tokenized format, and only detokenize the data while actively accessing, using, and/or modifying the data.

One approach that reduces risks in performing such a migration is to migrate workloads to the cloud in an incremental manner, such that certain applications or functions are migrated to the cloud while the rest of the workload remains on the local computing system. In order to facilitate such an approach, the latest data updates should be made accessible and available for processing in both the local computing system and cloud in near real-time, so that the migrated workloads can continue to function in the cloud while the rest of the workloads remain operational on the local computing system.

In particular, an example embodiment of the techniques of the present disclosure is a method for capturing changes in data during data migration and updating data stored at a local computing system. The method includes receiving, via one or more processors of a cloud server, local computing data from one or more databases associated with a local computing system while an active application is running on the local computing system, the local computing data including at least (i) one or more application functionalities and (ii) input data used by the active application. The method further includes capturing, via the one or more processors of the cloud server, change data based on the input data, the change data representative of one or more modifications to the input data by the one or more application functionalities. Furthermore, the method includes replicating, via the one or more processors of the cloud server, the change data to generated replicated data for the active application.

In some aspects of the embodiment, the method includes transmitting the replicated data to the local computing system, wherein the replicated data causes the local computing system to update data stored in the one or more databases.

In further aspects of the embodiment, the input data includes tokenized input data as generated according to a tokenization scheme and the method further comprises detokenizing at least the replicated data prior to the transmitting. Similarly, in further such aspects, generating the change data using the input data comprises performing one or more operations on the tokenized input data according to the one or more application functionalities.

In still further aspects of the embodiment, the active application includes one or more functionalities not yet present at the cloud server.

In yet still further aspects of the embodiment, receiving the local computing data is responsive to a user initiating a data migration procedure and the method further comprises until the data migration procedure ends, repeating each of: (i) receiving the local computing data, (ii) capturing the change data, (iii) replicating the change data, and (iv) transmitting the replicated data. In further such aspects, the one or more application functionalities are a first subset of a plurality of application functionalities, and the data migration procedure ends responsive to receiving a remainder of the plurality of application functionalities.

In further aspects of the embodiment, the local computing data includes stream data representative of one or more changes to one or more records stored at the one or more databases and receiving the local computing data is responsive to one or more real-time changes to the one or more records.

In still further aspects of the embodiment, the local computing data includes one or more files stored at the one or more databases and representative of one or more records.

In still yet further aspects of the embodiment, the method further comprises receiving, from an external computing device external to the local computing system, external data; and processing the external data according to the one or more application functionalities. In further such aspects, the method further comprises replicating the processed external data to generate replicated external data; and transmitting the replicated external data to the local computing system, wherein the replicated external data causes the local computing system to update data stored in the one or more databases. Similarly, in still further such aspects, the method further comprises tokenizing the external data to generate tokenized external data prior to the processing; and detokenizing the replicated external data prior to the transmitting the replicated external data.

Another embodiment of these techniques is a computing system configured to capture changes in data during data migration and update data stored at a local computing system. The computing system includes one or more processors configured to function as a cloud server and a non-transitory computer-readable medium storing instructions thereon. When executed by the one or more processors, the instructions cause the one or more processors to receive local computing data from one or more databases associated with a local computing system while an active application is running on the local computing system, the local computing data including at least (i) one or more application functionalities and (ii) input data used by the active application. The instructions further cause the one or more processors to generate change data using the input data, the change data representative of one or more modifications to the input data by the one or more application functionalities. Furthermore, the instructions further cause the one or more processors to replicate the change data to generated replicated data.

Yet another embodiment of these techniques is a non-transitory computer-readable memory coupled to one or more processors and storing instructions thereon When executed by the one or more processors, the instructions cause the one or more processors to capture changes in data during data migration and update data stored at a local computing system. In particular, the instructions cause the one or more processors to receive local computing data from one or more databases associated with a local computing system while an active application is running on the local computing system, the local computing data including at least (i) one or more application functionalities and (ii) input data used by the active application. The instructions further cause the one or more processors to generate change data using the input data, the change data representative of one or more modifications to the input data by the one or more application functionalities. Furthermore, the instructions further cause the one or more processors to replicate the change data to generated replicated data.

### BRIEF DESCRIPTION OF THE DRAWINGS

FIG. 1 illustrates a block diagram of an example high-level architecture for an example local computing system and cloud computing system in which techniques for capturing and transmitting change data can be implemented;

FIG. 2 illustrates a block diagram of a detailed local computing system and a detailed cloud server in which techniques for capturing and transmitting change data can be implemented;

FIG. 3 illustrates a block diagram of an example of a system for capturing and transferring streaming data between a local computing system and a cloud server;

FIG. 4A illustrates a data flow diagram for capturing and transferring hierarchical data from a local computing system to a cloud platform;

FIG. 4B illustrates a data flow diagram similar to that of FIG. 4A, but in which the local computing system captures and transfers relational data to a cloud platform;

FIG. 5A illustrates a data flow diagram for transferring hierarchical data from a cloud platform to a local computing system in real-time;

FIG. 5B illustrates a data flow diagram similar to that of FIG. 5A, but in which the cloud platform transfers relational data to a cloud platform;

FIG. 6A illustrates a data flow diagram similar to that of FIG. 5A, but in which the cloud platform transfers hierarchical data in a batch download;

FIG. 6B illustrates a data flow diagram similar to that of FIG. 6A, but in which the cloud platform transfers relational data to a cloud platform; and

FIG. 7 illustrates a data flow diagram of an example method for capturing changes in data during data migration and updating data stored at a local computing system, which may be implemented in a cloud server.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

### Example Hardware and Software Components

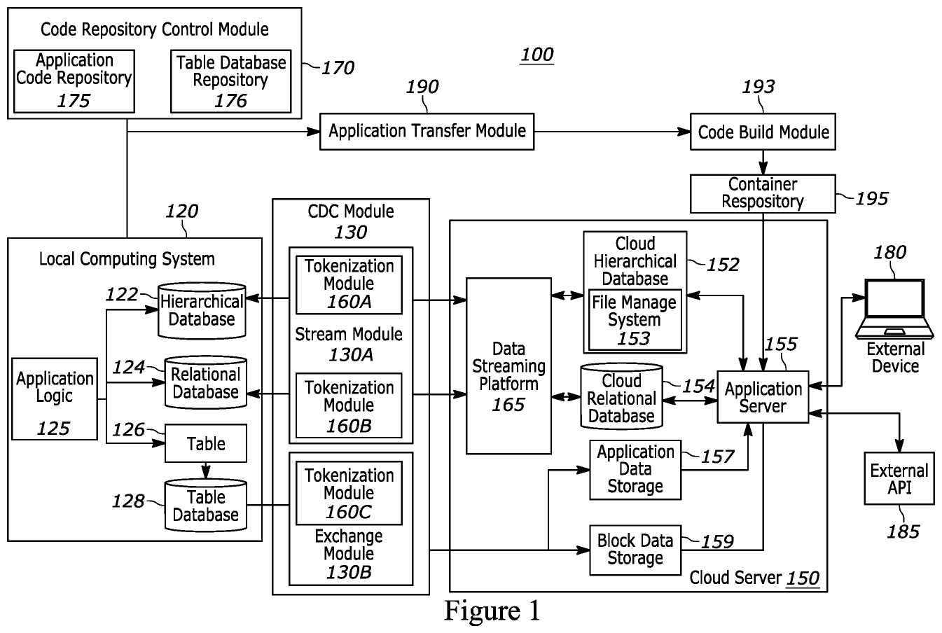

FIG. 1 depicts a high-level architecture for an example local computing data capture and transfer system 100. In some implementations, the system 100 includes at least some of: a local computing system 120, a change data capture (CDC) module 130, a cloud server 150, a code repository control module 170, an application code transfer module 190, a code build module 193, a container repository 195, an external device 180, and/or an external API 185, as described below. Depending on the embodiment, some such elements may be components of other elements. For example, the local computing system 120 may include the CDC module 130, and the code repository control module 170 may include at least some of the application transfer module 190, code build module 193, and/or container repository 195. In further implementations, some exemplary elements of the system 100 may be external to the system 100.

In some embodiments, the elements of the system 100 may communicate via wireless signals over a digital network, which can be any suitable local or wide area network(s) including a Wi-Fi network, a Bluetooth network, a cellular network such as 3G, 4G, Long-Term Evolution (LTE), 5G, the Internet, etc. In some instances, the elements of the system 100 may communicate via an intervening wireless or wired device, which may be a wireless router, a wireless repeater, a base transceiver station of a mobile telephony provider, etc.

In further embodiments, the elements of the system 100 may communicate via a direct wired connection. In some such embodiments, the direct wired connection allows for large volumes of data to be transmitted with sufficient bandwidth for the data and/or connection to remain resilient, secure, and/or stable during transfer.

In an example implementation, the local computing system 120 may be an application server, a web server, etc., and includes a memory, an operating system, one or more processors (CPU), such as a microprocessor, coupled to a memory, a network interface unit, and an I/O module, which may be a keyboard or a touchscreen, for example.

The local computing system 120 may also include and/or be communicatively coupled to one or more databases. In the exemplary embodiment of FIG. 1, the local computing system 120 includes data management databases, such as a hierarchical database 122 (e.g., an information management system (IMS) database, a domain name system (DNS) database, etc.), a relational database 124 (e.g., a DB2 database, a Sybase database, etc.), and a table database 128 (e.g., a BDAM database) fed into by table 126 (e.g., a tableBase functioning as a lookup table). Depending on the implementation, a local computing system 120 may include additional, fewer, or alternate databases. The databases may be or include one or more hard disk drives, optical storage drives, solid state storage devices, etc.

The hierarchical database 122 and/or relational database 124 may store data in rows and/or columns representative of data fields in records. A change to any particular row, column, or intersection thereof may be captured in real-time as described herein. The table database 128 may be representative of a particular file with multiple records, and the table 126 may be a lookup table for accessing and/or updating specific information in the file. In particular, an application may use the table 126 to access and/or update the information in the file. In some such implementations, a change to a particular record may therefore be captured as an entire batch file and the local computing system 120 may push the entire file as described in detail below.

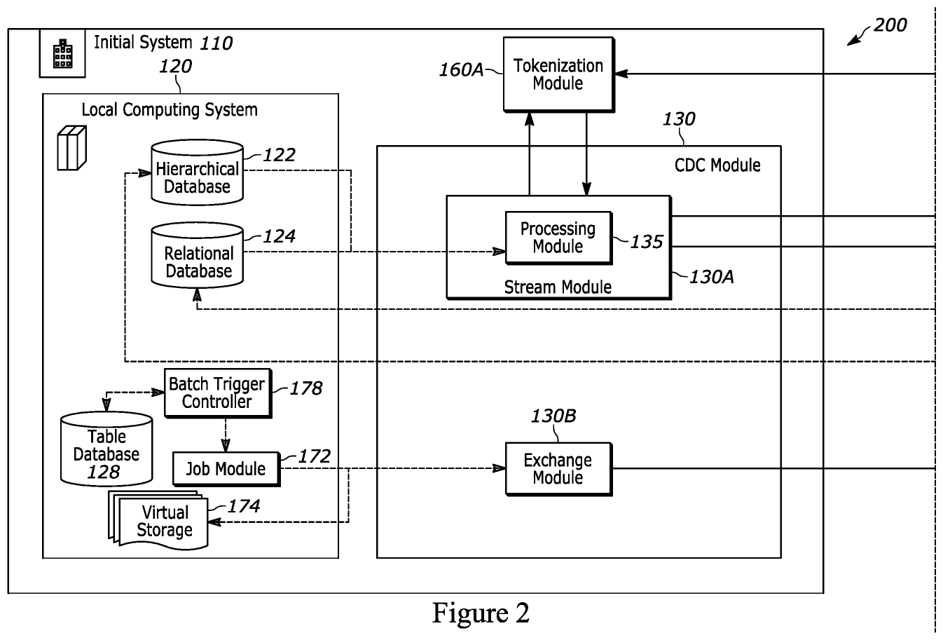

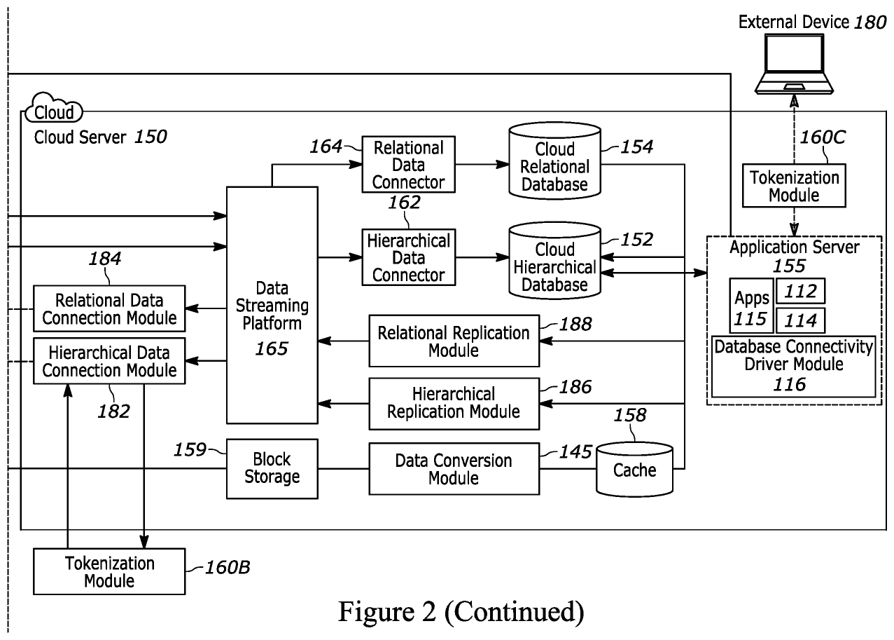

The hierarchical database 122, relational database 124, and/or table database 128 may include data used by one or more application logic 125 stored on and/or interacting with the local computing system 120. Depending on the implementation, the application logic 125 uses data from the hierarchical database 122, relational database 124, and/or table database 128 in performing various operations. For example, depending on the implementation, the application logic 125 may be for analyzing, updating, and/or otherwise using personally identifiable information (PII, e.g., a name, address, phone number, personal identifier, etc.), protected health information (PHI), insurance information, personal finance information, browsing information, habit information, survey information, payment information, and/or any other such information, and may retrieve and/or use relevant data from the hierarchical database 122, relational database 124, and/or table database 128. In some implementations, the application logic 125 updates, queries, and/or otherwise interacts with the databases. The code repository control module 170 includes an application code repository 175 storing application code to carry out application logic 125 (e.g., COBOL code for the application). In some such implementations, the application code repository 175 serves as a code repository for the applications running in application logic 125 and the table database repository 176 serves as a repository for table database 128. Depending on the implementation, the code repository control module 170 may be part of the local computing system 120, part of a broader computing network/environment (e.g., initial system 110 as described below with regard to FIG. 2), part of another computing device associated with the local computing system 120, etc.

While transferring data from the local computing system 120 to a cloud server 150 (e.g., as part of a data migration as described in more detail below), the local computing system 120 may transfer data to the cloud server 150 via a CDC module 130. Depending on the implementation, the CDC module handles data replication, data capture, real-time data transfer between the local computing system 120 and the cloud server 150, tokenization, batch uploads and/or downloads between the local computing system 120 and the cloud server 150, etc. Depending on the implementation, the CDC module 130 includes and/or interfaces with other modules, such as a data replication module (e.g., an infosphere data replication (IIDR) module), a tokenization module (e.g., data tokenization module(s) 160), an exchange module 130B (e.g., as described below with regard to FIG. 2), a stream module 130A (e.g., as described below with regard to FIG. 2), etc. In some implementations, the CDC module 130 includes additional, fewer, or alternative modules as described below with regard to FIG. 2.

In implementations in which the code for the application logic 125 is stored at an application code repository 175, the code repository control module 170 may package and deploy the application code in the application code repository 175 to the application server 155 on the cloud server 150 via an application transfer module 190. In some implementations, the application transfer module 190 includes components and/or modules to handle managing and/or transferring the source code for the application (e.g., Bitbucket), a code build module 193 (e.g., to compile, build, and/or test the application source code for the cloud server 150), a container repository 195 to store and share components of the application source code with the cloud server 150 (e.g., a Quay-based module), a component to integrate a version control system at the code repository control module 170 and the other modules in the application transfer module 190.

The cloud server 150 may include one or more tokenization modules 160A, 160B, and/or 160C (referred to collectively herein as tokenization modules 160). Depending on the implementation, the tokenization modules 160 perform a tokenization and/or detokenization process by interfacing with an external tokenization module that performs a tokenization and/or detokenization process and/or otherwise perform processes associated with encryption of data as described below with regard to FIG. 2.

The cloud server 150 further includes one or more databases such as a cloud hierarchical database 152, a cloud relational database 154 to store relational data, an application data storage 157 (e.g., a persistent database or an in-memory database), and a block data storage 159. In some implementations, the cloud hierarchical database 152, cloud relational database 154 for relational data, block data storage 159, etc. store the data transferred from corresponding databases at the local computing system 120. In further implementations, the application server 155 interacts with such databases to perform operations on (e.g., update) the stored data. In still further implementations, the application data storage 157 and/or another module functions as or is a cache memory storage, and stores frequently-accessed data for quick retrieval to improve the speed, performance, and scalability of the application server 155.

The databases of the local computing system 120 and/or cloud server 150 (e.g., the application data storage 157) may store data persistently or in-memory, and may include any types of suitable memory modules, including random access memory (RAM), read only memory (ROM), flash memory, other types of memory, etc. The memory may store, for example instructions executable on the processors for an operating system (OS) which may be any type of suitable operating system. The memory may also store, for example instructions executable on the processors for the CDC module 130, the application transfer module 190, the tokenization modules 160, etc.

In some implementations, the cloud server 150 includes a data stream platform 165 (e.g., PostgreSQL). Depending on the implementation, the data stream platform 165 may be a relational database and may organize the databases in tables to store relational data and or other relational local computing data. Additionally or alternatively, each individual database (e.g., cloud hierarchical database 152) may include a file management system 153 for file-based storage. The data stream platform 165, depending on the implementation, may additionally interface with the CDC module 130 to update data at the local computing system 120 as described in more detail below with regard to FIG. 2. In some implementations, the CDC module 130 and/or cloud server 150 updates at least some of the databases (e.g., the hierarchical database 122, the relational database 124, etc.) in real-time, while updating the other databases (e.g., the table database 128, etc.) as batch uploads/downloads. Similarly, the local computing system 120 may update the corresponding databases of the cloud server 150 in real-time and/or as batch uploads/downloads.

The local computing system 120 and/or the cloud server 150 may include a controller. The controller may include a program memory, a microcontroller or a microprocessor (MP), a random-access memory (RAM), and/or an input/output (I/O) circuit, all of which may be interconnected via an address/data bus. The controller may be communicatively coupled to the hierarchical database 122, the relational database 124, the table 126, the table database 128, etc. The memory of the controller may include multiple RAMs and/or multiple program memories implemented as semiconductor memories, magnetically readable memories, optically readable memories, etc. The memory may store various application (e.g., the application in application code repository 175 and/or application logic 125) for execution by the microprocessor. Similarly, the I/O circuit may include a number of different types of I/O circuits.

In further implementations, the cloud server 150 is communicatively coupled to and/or interfaces with an external device 180 and/or an external API 185 to connect to further applications and/or devices. The external device 180 may include, by way of example, a tablet computer, a network-enabled cell phone, a personal digital assistant (PDA), a mobile device smart-phone (also referred to herein as a “mobile device”), a laptop computer, a desktop computer, a portable media player, a wearable computing device such as Google Glass™, a smart watch, a phablet, a mainframe terminal screen, an emulated terminal screen, or any device configured for wired or wireless RF (Radio Frequency) communication, etc.

Turning now to FIG. 2, system 200 may include a local computing system 120 and a cloud server 150. Depending on the implementation, the local computing system 120 may be a part of a broader initial system 110 or may include one or more components described herein as otherwise being components of the initial system 110. Similar components of system 200 to components of system 100 are numbered similarly. As such, components of the system 200 that share numbering with a component of system 100 is to be understood as similar to the corresponding component of system 100, with differences described below.

The local computing system 120 may include multiple databases (e.g., hierarchical database 122, relational database 124, table database 128, etc.) and/or code repository control module 170. Further, the local computing system 120 may include a virtual storage 174 that manages the hierarchies and/or data storage capabilities of the local computing system 120 (e.g., a generation data group (GDG) and/or virtual storage access method (VSAM) architecture). The local computing system 120 may also include a job module 172 that interfaces with the code repository control module 170 to perform jobs in order to transfer files in batches to the cloud server 150 and/or receive data files from the cloud server 150. Depending on the implementation, the job module 172 may schedule data transfers in batches (e.g., with an event scheduler).

In some implementations, the local computing system 120 may interface with elements of a CDC module (e.g., the CDC module 130 as described above with regard to FIG. 1). Depending on the implementation, the CDC module may include other modules, such as a stream module 130A and/or an exchange module 130B. In some implementations, the stream module 130A includes a processing module 135 and facilitates transfer of changes to data stored in databases at the local computing system 120. In particular, the stream module 130A captures and/or receives changes to data stored at the hierarchical database 122 and/or relational database 124 in real-time and facilitates transfer of such changes to the cloud server 150. In some implementations, the stream module 130A interfaces with a tokenization module 160A to retrieve an initial hash for tokenizing the received change data.

In further implementations, the processing module 135 may be or include a replication engine for change data capture and to enable hierarchical and relational fields of data to be tokenized before transmitting to the cloud server 150. In particular, the replication engine may include an operation processor to generate classes to facilitate tokenization of hierarchical or relational fields in data. For example, the processing module 135 may create a class (e.g., a Java class) to be used for tokenizing via a tokenization service or module (e.g., tokenization module 160A). Additionally or alternatively, the generated classes may use heuristics to ensure that no private information (e.g., personally identifiable information, personal health information, personal financial information, etc.) is sent unsecured. For example, the system may be trained to identify when such information is found in a hierarchical or relational field that is not tokenized and either tokenize the field or transmit an alert regarding such.

Depending on the implementation, the tokenization module 160A and/or stream module 130A tokenizes the change data in near real-time such that the tokenized change data meets cryptographic regulatory standards and/or is tokenized accordingly to a deterministic scheme (e.g., multiple sources can tokenize the same value to get the same response). Similarly, the tokenization module 160A and/or stream module 130A may tokenize the change data according to a format-preserving scheme (e.g., char to char, int to int, float to float, etc.) so as to prevent wide-scale schema changes.

The tokenization module 160A and/or stream module 130A may receive the data and generate a hash value representative of the data. Depending on the implementation, the tokenization module 160A and/or processing module 135 may store the data and return the hash value for transfer and storage at the cloud server 150. In some such implementations, the tokenization module 160A and/or processing module 135 checks the appropriate policy once and generates the hash value once before keeping the data cached in memory to be used for any other future calls. Depending on the implementation, the policy may be associated with a particular privacy scheme and/or regulation (e.g., HIPAA, GLBA, etc.).

In further implementations, the tokenization module 160A and/or processing module 135 is called (e.g., via an API, SDK, JDBC, etc.) to tokenize the data by applying a cyphertext (e.g., based on the initial hash value) to a particular field in the data (e.g., a field containing or representative of personal information). The tokenization module 160A and/or processing module 135 may then replace the relevant fields and/or data with the cyphertext, which the tokenization module 160A and/or processing module 135 may later decrypt to detokenize. Depending on the implementation, the tokenization module 160A and/or processing module 135 may be trained (e.g., by a machine learning algorithm) to detect the presence or absence of a particular field and determine whether to tokenize the detected field. As such, the tokenization module 160A and/or processing module 135 may provide increased security through encryption and further tokenization.

In some implementations, the tokenization module 160A is or is stored on a server that stores encryption structure and policies. The tokenization module 160A may be a service called through a call from an application (e.g., via an API, SDK, JDBC, etc.). In some implementations, upon being called, the processing module 135 identifies data or a field that is to be tokenized (e.g., based on what a user is authorized to see, a presence of determined personally identifiable information, a flag, etc.). The tokenization module 160A, therefore, performs field-level encryption (FLE) to convert an open text field to tokenized or otherwise de-identified data.

It will be understood that, although a single tokenization module 160A is displayed, multiple tokenization modules may assist with and/or perform the tokenization for the change data. Further, it will be understood that another tokenization module besides tokenization module 160A may assist with and/or perform the tokenization, and similarly such a tokenization module may be a component of the local computing system 120, the initial system 110, the cloud server 150, and/or external to the components of system 200.

It will further be understood that, although the disclosure herein discusses FLE, a tokenization module 160 may apply any granularity of tokenization as appropriate. For example, a user, the tokenization module 160, a stored policy, processing module 135 etc. may determine an appropriate level of granularity for tokenizing the data.

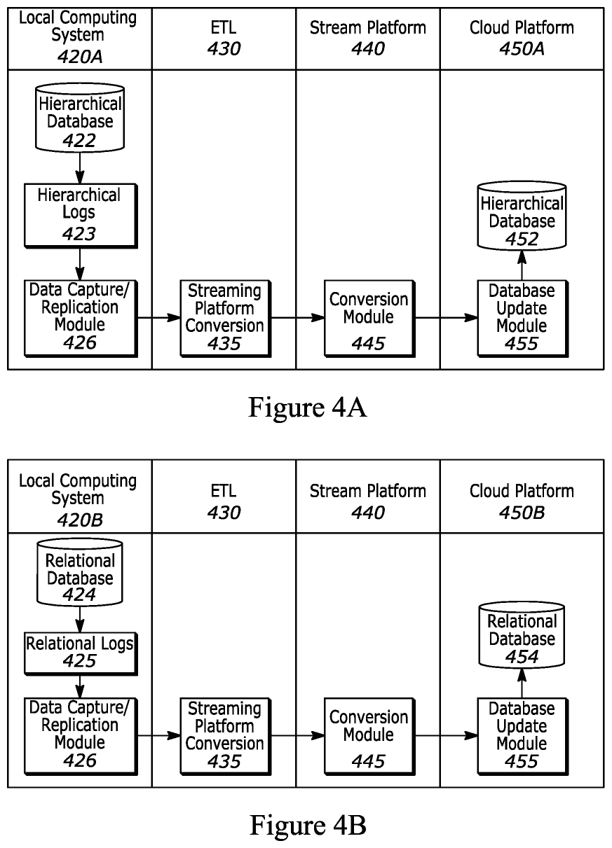

After the tokenization module 160A and/or processing module 135 tokenizes the change data, the stream module 130A pushes the encrypted/tokenized change data to the cloud server. In particular, the stream module 130A may push the encrypted/tokenized change data to data stream platform 165. The data stream platform 165 then stores the data while tokenized. In some implementations, the data stream platform 165 detokenizes the data to read or move the data back to the local computing system, but otherwise leaves the data tokenized. Depending on the implementation, the data stream platform 165 may be a component of, include, and/or be a data streaming platform (e.g., Kafka), as described below with regard to FIGS. 4A-6B.

In some implementations, the tokenization module 160A operates on the local computing system 120 or on another server such as an enterprise security administration (ESA) server (not shown) in the initial system 110. In some such implementations, the tokenization module 160A remains on the local computing system 120 or on another server while migration occurs. Depending on the implementation, the cloud server 150 interfaces with the tokenization module 160B directly to perform any tokenization and/or detokenization. In some implementations, the cloud server 150 includes another tokenization module (e.g., tokenization module 160C) and may continue to interact or may stop interaction with the tokenization module 160A on the ESA server after the data migration occurs. The ESA server in some implementations may be installed on the cloud server 150 and the cloud server 150 may interact exclusively with that instance.

In further implementations, the cloud server 150 tokenizes the data rather than receiving tokenized data. For example, the data stream platform 165, a tokenization module 160C, or another module may enable hierarchical and/or relational fields in data to be tokenized before being stored (e.g., as a topic for data streaming platforms such as Kafka). In particular, a producer API of the data stream platform 165 may include components (e.g., a Java plugin, etc.) to tokenize fields with sensitive information (e.g., personally identifiable information, personal health information, personal financial information, etc.) before storing the data. In implementations in which data is stored on a topic, ordering may be performed using specific topics or may be generally ordered by the data stream management module automatically. For example, the data stream platform 165 may order the data in topics such as IMSDB—Partitions; DB2-Partitions, TableBASE—Partitions, IMSDB—All others, DB2—Provider Lookup, Mainframe TableBASE Topic, IMS Ordered Topic, DB2 Ordered Topic, TableBASE Ordered Topic. Additionally or alternatively, the data stream platform 165 may store the data according to transactional ordering (e.g., of multiple topics), historical ordering, historical consumer groups (e.g., to ensure data from within given time ranges can be consumed), real-time consumer groups, etc.

Although the data stream platform 165 is described as performing the above techniques, it will be understood that other components of system 200 may perform the techniques in conjunction with or in place of the data stream platform 165. For example, the CDC module 130 (e.g., including the stream module 130A and/or exchange module 130B) may similarly perform the above techniques. In further implementations, a separate module (e.g., a streaming platform as discussed with regard to FIGS. 4A-6B below) may perform such techniques.

The data stream platform 165 may then direct the captured change data to a cloud hierarchical database 152 and/or a cloud relational database 154 by way of a hierarchical data connector 162 (e.g., a data streaming system sink connector) and/or a relational data connector 164 (e.g., a data streaming system connector), respectively.

In some implementations, the application 115 (e.g., stored in the application code repository 175 described above with regard to FIG. 1) is deployed to the application server 155 through similar techniques and/or through an application transfer module (e.g., application transfer module 190 as described above with regard to FIG. 1), a code build module 193, and a container repository 195, interfaces with the cloud hierarchical database 152, cloud relational database 154, and/or other such databases of the cloud server 150 via the database connectivity driver module 116. The application server 155 may perform operations on and/or updates to the data stored at the cloud hierarchical database 152, cloud relational database 154, etc. via the online module 114 (e.g., for near real-time data updates) and/or the batch file module 112 (e.g., for large batch file updates). In further implementations, the application server 155 receives inputs and/or other data from an external device 180 and performs operations on and/or updates to the data stored on the cloud server 150 accordingly. In some such implementations, data from the external device 180 passes through a tokenization module 160C before the application server 155 performs any operations using the additional data.

Depending on the implementation, the application server 155 performs operations on the data using tokenized and/or otherwise encrypted data using the database connectivity driver module 116. In some implementations, the database connectivity driver module 116 includes a relational driver (e.g., to connect to the database and ensure the data persists) and/or a file driver (e.g., to assist in accessing non-relational data). In particular, the database connectivity driver module 116 does not detokenize the data to be operated upon (e.g., via a relational driver) before the application performs any required calculations and/or operations.

After the application server 155 updates, operates on, and/or otherwise modifies the stored data, the application server 155 may direct change data to the data stream platform 165 by way of replication modules. In particular, a hierarchical replication module 186 (e.g., a CDC replication module with data streaming system connectors for a file data source) and/or relational replication module 188 (e.g., a CDC replication module with data streaming system connectors for a relational data source). The replication modules replicate changes to data made by the application server 155 and stored in the Cloud relational DB 154 and cloud hierarchical DB 152 for updating the local computing system 120.

The data stream platform 165 may then push the change data back to the local computing system 120 to update the relevant databases with the change data via connection modules, such as a hierarchical data connection module 182 and/or a relational data connection module 184. In some implementations, the hierarchical data connection module 182 and/or relational data connection module 184 interface with a tokenization module 160B to detokenize the change data (e.g., by reversing the tokenization process). The hierarchical data connection module 182 and relational data connection module 184 consume the streamed data from the data stream platform 165 and publish the data to the databases hierarchical DB 122 and relational 124, respectively, of the local computing system 120.

In some implementations, the local computing system 120 additionally or alternatively transfers, to the cloud server 150, data that is updated via batch upload (e.g., by transmitting the entire file, including the changes, rather than just the changes when a change is detected). In such cases, the batch trigger controller 178 triggers the generation of an output data file that includes the changes within the entire file. In some implementations, such data is data stored in a network file system (NFS) and/or a server message block (SMB). As such, in some such implementations, data that is accessed and/or updated remotely may be transferred to the cloud server 150 in batches rather than in near real-time using the exchange module 130B.

In particular, an exchange module 130B transmits batches of files to a block data storage 159 that stores blocks of such files. In some implementations, the exchange module 130B interfaces with a tokenization module 160 to tokenize the data prior to transfer, similar to the processing module 135. The block data storage 159 may then transmit data to a data conversion module 145, which may emulate the table database 128 (and/or a table as described with regard to FIG. 1) to convert and/or update data at the cloud server 150.

In some implementations, the data conversion module 145 stores the converted data in the cache 158, and/or other such databases, that the application server 155 accesses frequently (e.g., via the batch file module 112). In further implementations, data accessed frequently at the cloud hierarchical database 152 and/or cloud relational database 154 are similarly stored at the cache 158 and/or at other caches and/or databases. The cloud server 150 may similarly update the local computing system 120 according to updated data from the data conversion module 145 and/or cache 158 as operated on by the application server 155.

Depending on the implementation, at least some of the architecture of the cloud server 150 may be transient and, therefore, may be repurposed once migration is complete. For example, at least some of the data stream platform 165, the hierarchical data connector 162, the relational data connector 164, the hierarchical data connection module 184, the relational data connection module, the hierarchical replication module 186, and the relational replication module 188 may perform functionalities related to the data migration and the cloud server 150 may therefore repurpose the resources for such after the data migration is complete. In particular, a data streaming platform (e.g., Kafka) operating as part of the data stream platform 165 or operating separately (e.g., as described above and with regard to FIGS. 4A-6B below) may perform organizational jobs and/or ordering tasks during the data migration process, and may therefore be discarded after the data migration is complete. Similarly, such a platform may operate as part of the local computing system 120 and the resources may similarly be repurposed after data migration.

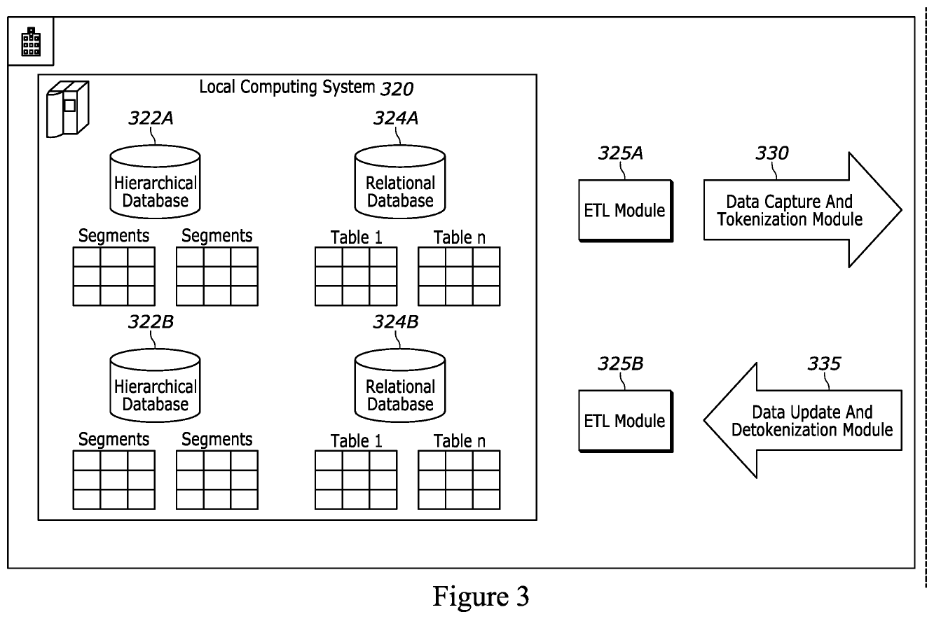

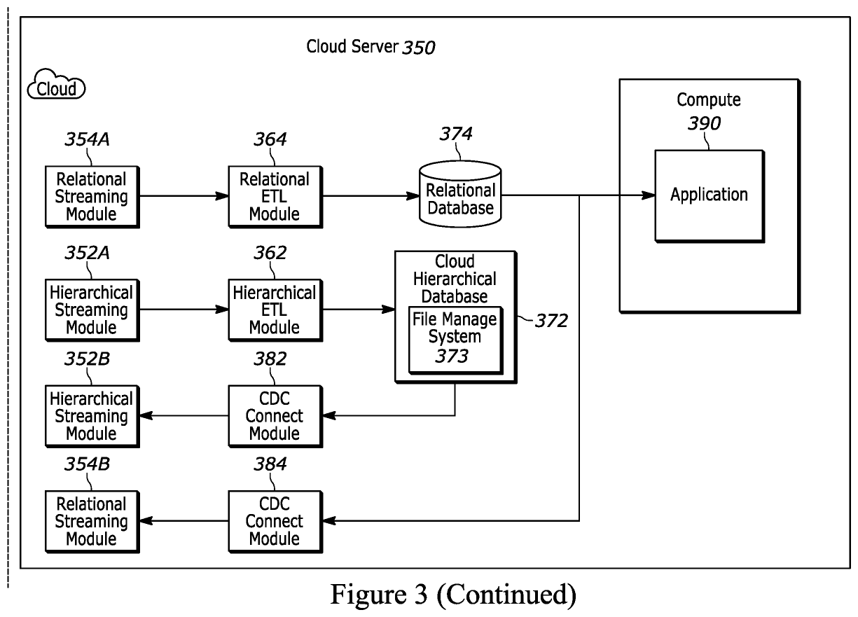

FIG. 3 illustrates an example data flow of a system 300 for capturing and transferring changes in data between a local computing system 320 and a cloud server 350. The local computing system 320 and the cloud server may resemble the local computing system 120 and cloud server 150, respectively, as described above with regard to FIGS. 1 and 2. In particular, the local computing system 320 may include a hierarchical database 322 and a relational database 324. It will be understood that FIG. 3 depicts the local computing system 320 before and after the process detailed herein. As such, the hierarchical database 322 and relational database 324 are depicted in a before state (e.g., hierarchical database 322A and relational database 324A) and an after state (e.g., hierarchical database 322B and relational database 324B). Where the respective database is agnostic to time and/or to refer to both states, it will be understood that the databases will be referred to as hierarchical database 322 and relational database 324, respectively.

The hierarchical database 322 stores data in a hierarchical model. Segments of the hierarchical database 322 represent records and contain fields or data elements. Depending on the implementation, at least some of the segments include child segments with related information (e.g., as indicated by pointers and/or links or via indexes). The relational database 324 stores data in a number of tables (e.g., n tables), each representing an entity or relationship between files. In further implementations, the rows represent individual records while columns represent attributes or fields.

The local computing system 320 transfers data to the cloud server 350 using a data capture and tokenization module (e.g., similar to the CDC module 130 described above with regard to FIG. 1). In some implementations, the local computing system 320 first transmits the data to an extraction, transformation, and loading (ETL) module 325A. Depending on the implementation, the ETL module 325A may identify and extract data from the local computing system 320 and the relevant databases (e.g., according to an automated process determination, according to an indication from a user, etc.). In further implementations, the ETL module 325A transforms, aggregates, and/or otherwise converts the data from a format for the local computing system 320 to a format utilized by the could server 350. Depending on the implementation, the ETL module 325A may further manipulate the data by cleaning, validating, aggregating, normalizing, or otherwise modifying the data. In still further implementations, the ETL module 325A loads the data (after transformation if the ETL module 325A transforms the data) to the target cloud server 350.

In some implementations, the ETL module 325A is part of the data capture and tokenization module 330. As such, depending on the implementation, the data capture and tokenization module 330 may capture the change data as part of the extraction through the ETL module 325A, tokenize the data as part of the transformation through the ETL module 325A, etc.

The cloud server 350 receives the data at a hierarchical streaming module 352A and/or a relational streaming module 354A. The hierarchical streaming module 352A and/or relational streaming module 354A direct the received data to a hierarchical ETL module 362 or a relational ETL module 364, respectively. Depending on the implementation, each of the hierarchical ETL module 362 and the relational ETL module 364 function similarly to the ETL module 325A. In particular, the hierarchical ETL module 362 loads the data to a cloud hierarchical database 372 and the relational ETL module 364 loads the data to a cloud relational database 374, similar to the cloud hierarchical database 152 and the cloud relational database 154 as described with regard to FIG. 2.

In some implementations, the cloud hierarchical database 372 includes a file management system 373 to manage file-based data. In further implementations, the relational database includes a similar management system (not shown) for relational databases. In the exemplary embodiment, the relational database 374 interfaces with an application 390 that spins up a computation server to perform operations on data in the relational database. In further implementations, the cloud hierarchical database 372 similarly interfaces with the application 390 and/or a similar such compute.

After the application 390 performs operations on the data and generates change data, the cloud server transfers the change data to the local computing system 320 via CDC connect modules 382/384 and streaming modules (e.g., hierarchical streaming module 352B and/or relational streaming module 345B). Depending on the implementation, the streaming modules may resemble the streaming modules receiving the data from the data capture and tokenization module 330, and the CDC connect modules 382/384 may resemble the hierarchical data connection module 182 and/or relational data connection module 184 as described with regard to FIG. 2. In further implementations, each of the CDC connect modules 382/384 may include replication features similar to the hierarchical replication module 186 and/or relational replication module 188 as described with regard to FIG. 2. A data update and detokenization module 335 (e.g., similar to the data capture and tokenization module 330) may then receive the messages from the streaming modules 352B and 354B and transmit the data from the cloud server 350 to the local computing system 320 (e.g., via an ETL module 325B).

FIGS. 4A and 4B illustrate a write process for transferring data from an on-premises local computing system (e.g., local computing system 120) to a cloud platform (e.g., cloud server 150). In particular, FIG. 4A illustrates a local computing system 420A transferring data from a hierarchical database 422 to a cloud platform 450A. FIG. 4B illustrates a similar local computing system 420B transferring data from a relational database 424 to a similar cloud platform 450B. Depending on the implementation, the local computing system 420A and the local computing system 420B may be the same local computing system 420, the cloud platform 450A and the cloud platform 450B may be the same cloud platform 450, etc.

In FIG. 4A, the local computing system 420A pulls data from the hierarchical database 422 in the form of hierarchical logs 424 representative of one or more changes to the data in the hierarchical database 422. The local computing system 420A then captures and replicates change data according to the hierarchical logs 423 using a data capture/replication module 426. Depending on the implementation, the data capture/replication module 426 may function similarly to, be a component of, or include the CDC module 130 (e.g., as described above with regard to FIGS. 1 and 2).

An ETL module 430 (e.g., similar to ETL module 325A) then extracts, transforms, loads, and/or otherwise processes the data from the data capture/replication module 426 to load the data to a streaming platform 440 via a streaming platform conversion 435. In some implementations, the streaming platform 440 follows a publish-subscribe model, where producer applications or components write messages to the streaming platform 440 and consumer applications or components read the messages from the streaming platform 440. In particular, the local computing system 420A writes to the streaming platform 440 via the ETL module 430 and/or streaming platform conversion 435, and the cloud platform 450A reads from the stream platform 440 via a conversion module 445. Depending on the implementation, the streaming platform may be or include, for example, a Kafka platform, an AWS Kinesis platform, etc.

The streaming platform 440 then converts the data as appropriate via a conversion module 445 before transmitting the data to the cloud platform 450A. At the cloud platform 450A, a database update module 455 (e.g., data stream platform 165 as described above with regard to FIGS. 1 and 2) receives the data from the streaming platform 440 and updates the hierarchical database 452 according to the data. FIG. 4B largely illustrates a similar process to the process illustrated in FIG. 4A, but with a relational database 424, relational logs 425, and a relational database 454 rather than a hierarchical database 422, hierarchical logs 423, and a hierarchical database 452.

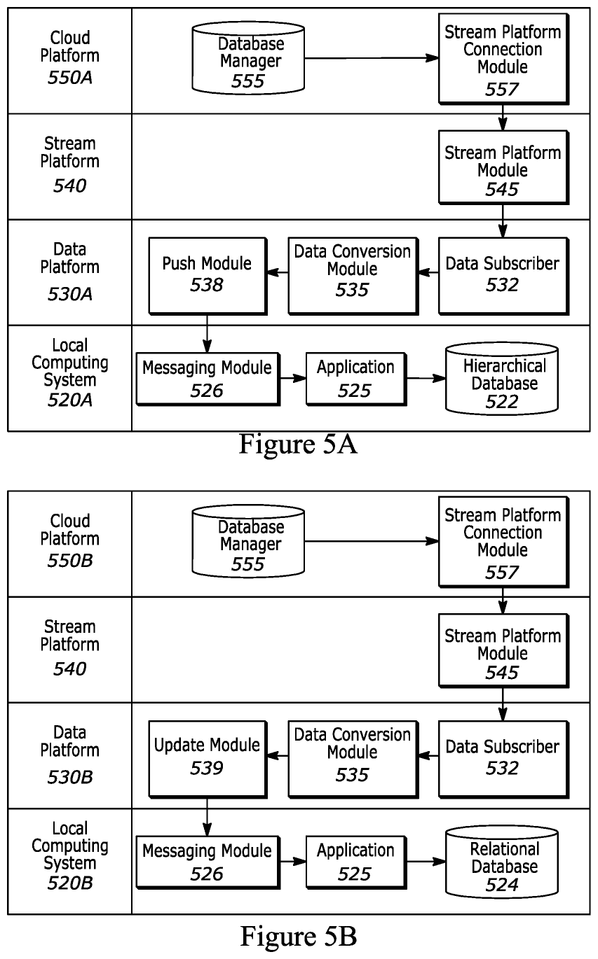

FIGS. 5A and 5B illustrate a write process similar to the process described above with regard to FIGS. 4A and 4B, respectively, but in which the cloud platform (e.g., cloud server 150) transfers data to a local computing system (e.g., local computing system 120). In particular, FIG. 5A illustrates a cloud platform 550A transferring data from a hierarchical database 422 to a hierarchical database 522 on a local computing system 520A. FIG. 5B illustrates a similar cloud platform 550B transferring data to a relational database 524 on a similar local computing system 520B. Depending on the implementation, the local computing system 520A and the local computing system 520B may be the same local computing system 520, the cloud platform 550A and the cloud platform 550B may be the same cloud platform 550, etc.

In FIG. 5A, the cloud platform 550A transmits data from various databases to a stream platform connection module 557 via a database manager 555. Depending on the implementation, the database manager 555 may be a part of, include, or be a data stream platform 165 as described with regard to FIGS. 1 and 2. Similarly, the stream platform connection module 557 may be a part of, include, or be a hierarchical data connection module 182 as described with regard to FIG. 2.

The stream platform connection module 557 then transmits the data to the streaming platform 540 (e.g., to a streaming platform module 545 configured to interact with the cloud platform 550A). Depending on the implementation, the stream platform module 540 may resemble the streaming platform 440 described with regard to FIGS. 4A and 4B, and any such implementations may similarly apply.

The streaming platform 540 transmits the data to a data platform 530 (e.g., the CDC module 130 or another platform/module). The data platform 530 receives the data at a data subscriber module 532 and converts the data at a data conversion module 535 for the local computing system 520A. The data platform 530 then pushes the data to the local computing system using a push module 538. In some implementations, the push module 538 pushes the data to a messaging module 526, such as a message queue (MQ), at the local computing system 520A.

The messaging module 526 receives the data and stores the data at a hierarchical database 522. In some implementations, an application 525 stored at the local computing system 520A receives the data and stores the data at the hierarchical database 522. In some implementations, the application 525 further modifies the stored data and triggers the process described with regard to FIGS. 4A and 4B again.

FIG. 5B is largely similar to FIG. 5A, but the cloud platform 530B publishes an update to the local computing system 520B via a update module 539 rather than pushing changes to the local computing system 520A using a push module 538 (e.g., via a two-way process rather than a one-way push). Similarly, the local computing system 520B updates a relational database 524 rather than a hierarchical database 522.

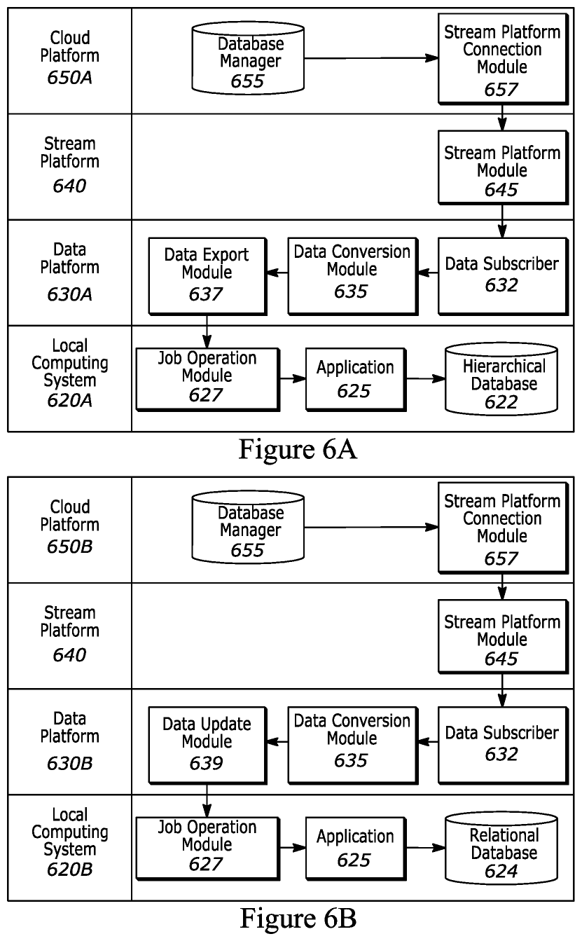

FIGS. 6A and 6B illustrate a write process similar to the process described above with regard to FIGS. 5A and 5B, respectively, but in which the data platform exports or updates data in conjunction with a job operation module of the local computing system 620. In particular, in FIG. 6A, a data export module 637 exports the data to the local computing system 620A according to a file transfer protocol (FTP) associated with the local computing system 620A. Similarly, the data platform 630B in FIG. 6B updates the local computing system 620B according to a data update module 639 similar to the data update module 539 described above with regard to FIG. 5B.

The local computing system 620 then receives the data at a job operation module 627 that receives the data in real-time or as a batch job. Depending on the implementation, the job operation module 627 specifies particular resources that the application 525 or the local computing system 620 use in updating the hierarchical database 622 or relational database 624. The job operation module 627 may operation according to Ctrl-M, job control language (JCL), etc.

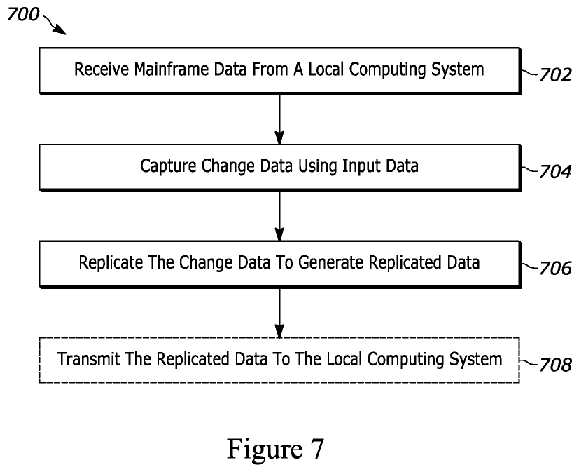

FIG. 7 illustrates an example method 700 for facilitating data capture, updating, and transfer (e.g., for data migration), which can be implemented at a cloud server (such as the cloud server 150), for example. The method can be implemented in a set of instructions stored on a computer-readable memory and executable at one or more processors of the cloud server 150. For example, the method can be implemented by the data stream platform 165.

At block 702, the cloud server 150 receives local computing data from a local computing system (e.g., local computing system 120). In some implementations, the local computing data includes one or more application functionalities and/or input data from one or more databases associated with the local computing system 120 (e.g., a hierarchical database 122, a relational database 124, a table database 128, etc.). The input data may be used by an active application, and the cloud server 150 may receive the local computing data while the active application is running on the local computing system 120. Depending on the implementation, the cloud server 150 may receive the application functionalities from an application transfer module (e.g., application transfer module 190) associated with the local computing system 120 via one or more containers including source code associated with the application functionalities. In some implementations, the active applications include one or more functionalities not yet present at the cloud server 150.

In some implementations, the local computing data includes stream data representative of one or more changes to one or more records stored at the one or more databases (e.g., the hierarchical data from the hierarchical database 122, the relational data from the relational database 124, etc.). In further implementations, the local computing data includes one or more files stored at the one or more databases. Depending on the implementation, the one or more files are representative of one or more records stored at the local computing system 120. Depending on the implementation, the cloud server 150 may receive (e.g., stream) stream data in real-time or near real-time when the stream data is updated at the local computing system 120 (e.g., where the stream data is representative of just the changes) and may receive the files as a batch upload (e.g., where each file is representative of more than just the changes). In some implementations, the local computing system 120 transfers the files responsive to a trigger (e.g., from a user) or other such indication to perform the transfer.

In further implementations, the input data includes tokenized input data as generated according to a tokenization and/or other such encryption scheme. In some such implementations, the local computing system 120 and/or a tokenization module associated with the local computing system 120 (e.g., tokenization module 160A) tokenizes or otherwise encrypts the input data prior to the cloud server 150 receiving the input data. In further such implementations, the cloud server 150 and/or a tokenization module associated with the cloud server 150 (e.g., tokenization module 160C) tokenizes or otherwise encrypts the input data after or while receiving the input data.

At block 704, the cloud server 150 generates change data using the input data. In some implementations, the change data is representative of one or more modifications to the input data by the one or more application functionalities. In further implementations, the cloud server 150 generates the change data responsive to input from a user (e.g., from an external device 180) and/or otherwise according to one or more changes made to the data stored at the cloud server 150 that may affect functionality of an active application at the local computing system 120.

At block 706, the cloud server 150 replicates the change data to generate replicated data. Depending on the implementation, the cloud server 150 may replicate only the change data, entire files, etc. In further implementations in which the data is tokenized, the cloud server 150 detokenizes the replicated change data prior to performing block 708 as described below.

At block 708, the cloud server 150 transmits the replicated data to the local computing system 120. In some implementations, the replicated data causes the local computing system 120 to update data stored in the one or more databases.

In some implementations, the cloud server 150 additionally or alternatively receives data from an external device (e.g., external device 180 as described with regard to FIG. 1 above). Depending on the implementation, the cloud server 150 may process the external data according to the one or more application functionalities received as part of the local computing data. In further implementations, the cloud server 150 additionally or alternatively replicates the processed external data to generate external data, similar to block 706. Similarly, the cloud server 150 may then transmit the replicated external data to the local computing system. Depending on the implementation, the replicated external data may cause the local computing system 120 to update the data stored in the one or more databases.

In further implementations, the cloud server 150 may additionally tokenize the external data to generate tokenized external data prior to the processing, as described above with regard to block 702. Alternatively, the external device 180 may tokenize the external data and/or cause the external data to be tokenized prior to transmitting the data to the cloud server 150. In further implementations, the cloud server 150 detokenizes the replicated external data prior to transmitting the data to the local computing system 120.

Depending on the implementation, the cloud server 150 may perform block 702 responsive to a user initiating a data migration procedure. In further such implementations, the cloud server 150 repeats blocks 702, 704, 706, and 708 until the data migration procedure ends. Depending on the implementation, the data migration procedure may end when a predetermined set of data is transferred from the local computing system 120 to the cloud server 150, when a predetermined set of application functionalities are transferred from the local computing system 120 to the cloud server 150, responsive to an indication to end the data migration (e.g., from a user via an external device 180), responsive to a determination that no new data is left on the local computing system 120, etc.

### Additional Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, as indicated above, at least some of the operations may be performed by a group of computers (as examples of machines including processors), these operations being accessible via a network (e.g., the Internet) and via one or more appropriate interfaces (e.g., APIs).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” or a “routine” is a self-consistent sequence of operations or similar processing leading to a desired result. In this context, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms.” “numbers,” “numerals,” or the like. These words, however, are merely convenient labels and are to be associated with appropriate physical quantities.

Unless specifically stated otherwise, discussions herein using words such as “processing,” “computing.” “calculating.” “determining.” “presenting.” “displaying.” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising.” “includes,” “including.” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Upon reading this disclosure, those of skill in the art will appreciate still additional alternative structural and functional designs for facilitating data migration from a local computing system to a cloud server through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for capturing changes in data during data migration and updating data stored at a local computing system, comprising:
receiving, via one or more processors of a cloud server, local computing data from one or more databases associated with a local computing system while an active application is running on the local computing system, the local computing data including at least (i) one or more application functionalities and (ii) input data used by the active application;
capturing, via the one or more processors of the cloud server, change data based on the input data, the change data representative of one or more modifications to the input data by the one or more application functionalities; and
replicating, via the one or more processors of the cloud server, the change data to generate replicated data for the active application.

2. The method of claim 1, the method further comprising:
transmitting the replicated data to the local computing system, wherein the replicated data causes the local computing system to update data stored in the one or more databases.

3. The method of claim 1, wherein the input data includes tokenized input data as generated according to a tokenization scheme and the method further comprises:
detokenizing at least the replicated data prior to the transmitting.

4. The method of claim 3, wherein generating the change data using the input data comprises:
performing one or more operations on the tokenized input data according to the one or more application functionalities.

5. The method of claim 1, wherein:
the active application includes one or more functionalities not yet present at the cloud server.

6. The method of claim 1, wherein:
the local computing data includes stream data representative of one or more changes to one or more records stored at the one or more databases; and
receiving the local computing data is responsive to one or more real-time changes to the one or more records.

7. The method of claim 1, wherein the local computing data includes one or more files stored at the one or more databases and representative of one or more records.

8. The method of claim 1, further comprising:
receiving, from an external computing device external to the local computing system, external data; and
processing the external data according to the one or more application functionalities.

9. The method of claim 8, further comprising:
replicating the processed external data to generate replicated external data; and
transmitting the replicated external data to the local computing system, wherein the replicated external data causes the local computing system to update data stored in the one or more databases.

10. The method of claim 9, further comprising:
tokenizing the external data to generate tokenized external data prior to the processing; and
detokenizing the replicated external data prior to the transmitting the replicated external data.

11. A computing system configured to capture changes in data during data migration and update data stored at a local computing system, comprising:
one or more processors configured to function as a cloud server; and
a non-transitory computer-readable medium coupled to the one or more processors and storing instructions thereon that, when executed by the one or more processors, cause the one or more processors to:
receive local computing data from one or more databases associated with a local computing system while an active application is running on the local computing system, the local computing data including at least (i) one or more application functionalities and (ii) input data used by the active application;
capture change data based on the input data, the change data representative of one or more modifications to the input data by the one or more application functionalities; and
replicate the change data to generate replicated data for the active application.

12. The computing system of claim 11, wherein the non-transitory computer-readable medium further stores instructions that, when executed by the one or more processors, cause the computing system to:
transmit the replicated data to the local computing system, wherein the replicated data causes the local computing system to update data stored in the one or more databases.

13. The computing system of claim 11, wherein the input data includes tokenized input data as generated according to a tokenization scheme and the non-transitory computer-readable medium further stores instructions that, when executed by the one or more processors, cause the computing system to:
detokenize at least the replicated data prior to the transmitting.

14. The computing system of claim 13, wherein generating the change data using the input data comprises:
performing one or more operations on the tokenized input data according to the one or more application functionalities.

15. The computing system of claim 14, wherein:
the active application includes one or more functionalities not yet present at the cloud server.

16. The computing system of claim 11, wherein:
the local computing data includes stream data representative of one or more changes to one or more records stored at the one or more databases; and
receiving the local computing data is responsive to one or more real-time changes to the one or more records.

17. The computing system of claim 11, wherein the local computing data includes one or more files stored at the one or more databases and representative of one or more records.

18. The computing system of claim 11, wherein the non-transitory computer-readable medium further stores instructions that, when executed by the one or more processors, cause the computing system to:
receive, from an external computing device external to the local computing system, external data; and
process the external data according to the one or more application functionalities.

19. The computing system of claim 18, wherein the non-transitory computer-readable medium further stores instructions that, when executed by the one or more processors, cause the computing system to:
replicate the processed external data to generate replicated external data; and
transmit the replicated external data to the local computing system, wherein the replicated external data causes the local computing system to update data stored in the one or more databases.

20. The computing system of claim 19, wherein the non-transitory computer-readable medium further stores instructions that, when executed by the one or more processors, cause the computing system to:
tokenize the external data to generate tokenized external data prior to the processing; and
detokenize the replicated external data prior to the transmitting the replicated external data.
